(19) United States
(12) Patent Application Publication
(10) Pub. No.: US 2004/0267854 A1
(43) Pub. Date: Dec. 30, 2004

(54) Logarithmic and inverse logarithmic conversion system and method

(76) Inventors: Towfique Haider, Allen, TX (US); Walter H. Demmer, Nuremberg (DE); Bart DeCanne, San Jose, CA (US)

Correspondence Address: W. Daniel Swayze, Jr., Texas Instruments Incorporated, M/S 3999, PO Box 655474, Dallas, TX, 75265, US

(21) Appl. No.: 10/606,505

(22) Filed: Jun. 26, 2003

(51) Int. Cl. G06F 1/02

(52) U.S. Cl. 708/512

(57) ABSTRACT

A system and method is provided for determining a logarithm of an input value and a system and method for determining an inverse logarithm for an input value. The system and method determine an integer value relating to the logarithm and performs a linear interpolation over a range relating to the integer value. A mantissa value is produced from the linear interpolation and corrected over one or more correction stages. The inverse logarithmic system and method receive an input value comprising an integer value and a mantissa value. The mantissa value is precorrected over one or more precorrection stages. The precorrected mantissa is then combined with a value related to the integer value and multiplied by a restoration factor to produce the inverse logarithm.

### TECHNICAL FIELD

The present invention relates generally to data conversion, and more particularly to logarithmic and inverse logarithmic converters.

### BACKGROUND OF THE INVENTION

Logarithmic conversion is used to simplify mathematical calculations in a variety of applications. In video correction applications, for example, it is often desirable to add or remove exponential powers from an input signal. In the standard domain, taking the signal to a particular exponential power can be computationally expensive, requiring lengthy series calculations. In the logarithmic domain, this can be accomplished by the multiplication of the logarithmic representation of the signal by the exponential factor. It will be appreciated that a substantial savings in processing time can be achieved by avoiding the exponential calculation.

Prior systems have often relied on look-up tables to determine the logarithm of an input value. Such look-up tables include a logarithmic conversion value for every possible input value that can be encountered by the system. Where a large number of input values are possible, however, the increased memory requirements make a comprehensive look-up table impractical. Other systems have attempted to calculate a Taylor power series to approximate the logarithmic value. While a Taylor power series can be extended to a desired degree of accuracy, the calculation of the necessary exponential factors can be time-intensive. Thus, Taylor series approximations can be inefficient for applications taking place in real-time.

A third method of calculating a logarithmic value includes piecewise linear approximation of the logarithmic curve. In piecewise linear approximation, the domain of all possible input values is divided into a series of subdomains. Each subdomain is represented by a set of parameters, which are used to approximate values falling within that subdomain. The parameters must either be derived for each input value or stored in memory. As the required accuracy of an application increases, so does the number of required parameters, increasing the burden of their derivation or storage.

Where calculation of a logarithm requires excessive expenditure of time or memory, the benefits of processing values within the logarithmic domain can be seriously curtailed. Accordingly, an efficient means for conducting logarithmic and inverse logarithmic conversions would be desirable.

### SUMMARY OF THE INVENTION

The following presents a simplified summary of the invention in order to provide a basic understanding of some aspects of the invention. This summary is not an extensive overview of the invention. It is intended neither to identify key or critical elements of the invention nor delineate the scope of the invention. Its sole purpose is to present some concepts of the invention in a simplified form as a prelude to the more detailed description that is presented later.

The present invention relates to a system and method for determining a logarithm of an input value as well as a system and method for determining the inverse logarithm of an input value. The system and method determine an integer value relating to the logarithm and perform a linear interpolation over a range relating to the integer value. A mantissa value is produced from the linear interpolation and corrected over one or more correction stages. The inverse logarithmic system and method receive an input value comprising an integer value and a mantissa value. The mantissa value is precorrected over one or more precorrection stages. The precorrected mantissa is combined with a value related to the integer value and multiplied by a restoration factor to produce the inverse logarithm.

In accordance with one aspect of the invention, a logarithmic conversion system determines a logarithm of a number. An integer determination portion determines an integer value associated with the logarithm. An interpolation portion performs a linear interpolation of the number over a range defined by two consecutive integer powers of the logarithmic base to obtain a mantissa value. The consecutive integer powers include a value derived from the integer value. At least one correction stage applies a correction factor to the mantissa value.

In accordance with another aspect of the invention, a logarithmic conversion system includes a leading one detector, at least one multiplexer, and at least one adder. The leading one detector determines the position of the leading one of a binary number to determine an integer value of a logarithm. The one or more multiplexers shifts the digits of the binary number such that the digit following the leading one occupies a first bit position of the number to determine a mantissa value for the logarithm. The one or more adders are operative to add a value to the mantissa value.

In accordance with yet another aspect of the invention, an inverse logarithmic conversion system receives an input value comprising an integer value and a mantissa value and determines the inverse logarithm of the input value for a predetermined base. At least one precorrection stage applies a correction factor to the mantissa value to produce a precorrected mantissa value. A restoration portion adds a value derived from the integer value to the precorrected mantissa. The mantissa is multiplied by a restoration factor equal to the difference between two consecutive integer powers of the logarithmic base.

In accordance with still another aspect of the invention, an inverse logarithmic conversion system produces the inverse logarithm of an input value comprising an integer value and a mantissa value. One or more adders apply a precorrection factor to the mantissa value. A header portion adds a leading one to the precorrected mantissa value. One or more multiplexers shift the digits of the binary number such that the leading one occupies a bit position associated with the integer value.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention will become apparent from the following d tailed description of the invention when considered in conjunction with the drawings.

### BRIEF DESCRIPTION OF THE DRAWINGS

FIG. 1 illustrates a functional block diagram of a logarithmic conversion system in accordance with an aspect of the present invention.

FIG. 2 illustrates a block diagram of an exemplary basic logarithmic converter in accordance with an aspect of the present invention.

FIG. 3 illustrates a block diagram of a first correction stage of an exemplary logarithmic converter in accordance with an aspect of the present invention.

FIG. 4 illustrates a block diagram of second and third correction stages of an exemplary logarithmic converter in accordance with an aspect of the present invention.

FIG. 5 illustrates a functional block diagram of an inverse logarithmic conversion system in accordance with an aspect of the present invention.

FIG. 6 illustrates a block diagram of a first precorrection stage of an exemplary logarithmic converter in accordance with an aspect of the present invention.

FIG. 7 illustrates a block diagram of second and third precorrection stages of an exemplary inverse logarithmic converter in accordance with an aspect of the present invention.

FIG. 8 illustrates a block diagram of an exemplary basic inverse logarithmic converter in accordance with an aspect of the present invention.

FIG. 9 illustrates a block diagram of a video correction system in accordance with an aspect of the present invention.

FIG. 10 illustrates an exemplary methodology for converting an input value into its logarithmic representation in accordance with an aspect of the present invention.

FIG. 11 illustrates an exemplary methodology for producing the inverse logarithm in accordance with an aspect of the present invention.

### DETAILED DESCRIPTION OF INVENTION

The present invention relates to a system and method for determining a logarithm of an input value. The system and method determine an integer value relating to the logarithm and performs a linear interpolation over a range relating to the integer value. A mantissa value is produced from the linear interpolation and corrected over one or more correction stages. The invention further relates to an inverse logarithmic system and method that receives an input value comprising an integer value and a mantissa value. The mantissa value is precorrected over one or more precorrection stages. The precorrected mantissa is combined with a value related to the integer value and multiplied by a restoration factor to produce the inverse logarithm.

The logarithmic and inverse logarithmic converters of the present invention operate more efficiently than conventional systems. The efficiency of converters is increased by relying on a single approximation to the logarithmic or exponential curve and correcting it, instead of the prior practice of approaching an idealized curve in a piecewise manner. For example, a logarithmic converter in accordance with the present invention having three correction stages requires only the original interpolation and the addition of three correction factors. Nevertheless, the use of these three correction stages achieves a level of accuracy approximately equal to that of a linear interpolation using eighteen sub-domains to approximate the logarithmic curve. It will be appreciated that the present invention offers significant savings in processing expense over conventional systems. Additionally, the present invention can be implemented, in one embodiment, as a collection of logic circuitry without the use of look-up tables or general processors.

In accordance with an aspect of the present invention, a correction factor is applied at each of one or more correction stages to produce corrected values of the mantissa. Each of these correction values can be calculated from the original mantissa value without knowledge of the action of the other correction stages. In other words, all of the correction stages, within both the logarithmic converter and the inverse logarithmic converter of the present invention, can be implemented as to calculate an associated correction factor independently from the correction factor of the other stages. This is more efficient than an iterative model, as it allows the correction factors for each stage to be calculated in parallel with the corrected mantissa values to which they will be provided, removing the need for a delay.

In the various implementations of the invention illustrated herein, the logarithmic and inverse logarithmic converters will be illustrated as base-two converters. In digital applications, it is frequently useful to operate in a base-two logarithmic domain, as this domain translates readily to the binary place values with the digital hardware. Where logarithmic values of other bases are desired, an appropriate scaling factor can be applied to the base-two logarithm to translate the value to the desired base. It will be appreciated, however, that the described system and method can be applied to logarithms of other bases where a direct calculation using a particular logarithmic base is desirable.

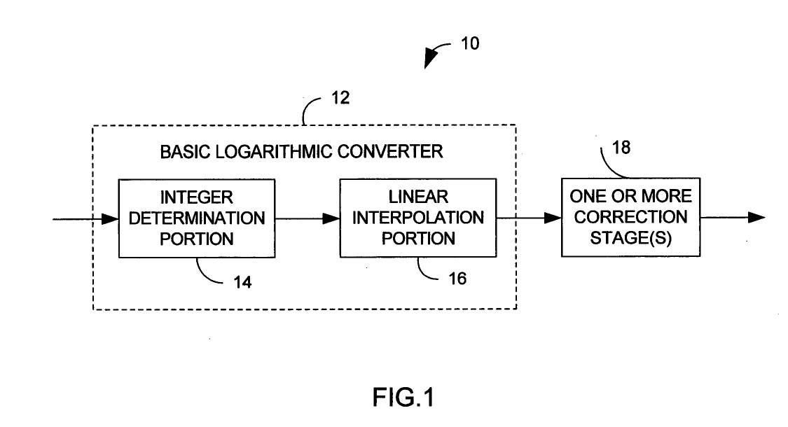

FIG. 1 illustrates a functional block diagram of a logarithmic conversion system 10 in accordance with one aspect of the present invention. The logarithmic converter 10 converts an input value into a logarithm of a predetermined base. The logarithmic converter 10 can be implemented as software on a general purpose processor. Alternatively, the logarithmic converter can be implemented as specialized hardware components.

The logarithmic conversion begins when an input value is received at a basic logarithmic converter 12. The basic logarithmic converter comprises an integer determination portion 14 and a linear interpolation portion 16. The integer determination portion 14 determines an integer value (I) associated with the logarithm of the value of the input value. This can be accomplished via logic circuitry, or through a software program running on a general purpose processor. The integer value is the whole number portion of the logarithm of the value.

The integer portion is provided to the linear interpolation portion 16. The linear interpolation portion 16 operates to calculate a mantissa portion of the logarithm from a linear interpolation of the input value across a range defined by two consecutive integer powers of the logarithmic base. Specifically, the range is bounded by the I^{th} power of the base and the (I+1)^{th} power of the base. Thus, for a base N logarithm, the value of the original mantissa for a value, V, can be expressed as:

$$Mantissa = \frac{V - {N}^{I}}{{N}^{I + 1} - {N}^{I}} \qquad Eq . 1$$

The integer value (I) and the original mantissa value are provided to a one or more correction stages 18. Any number of correction stages can be employed, depending on the desired accuracy of the application and an acceptable time range. Additional correction stages can increase the accuracy of the conversion at the cost of an increase in the required processing time and chip space. However, it has been found that an exemplary logarithmic converter that converts a ten-bit integer to its base-two logarithm required only three stages to achieve a maximum error of about 0.00388.

For example, at a first correction stage, a first correction factor can be applied to the original mantissa value to produce a first corrected mantissa value. The first corrected mantissa value can then be provided to a second correction stage. At the second correction stage, a second correction factor is applied to the first correction mantissa to produce a second corrected mantissa value. The second corrected mantissa value can then be provided to further correction stages, each stage providing a correction factor until a desired degree of accuracy is achieved. In accordance with one aspect of the invention, the correction factor at each stage can be a function of the original, uncorrected, mantissa value. It will be appreciated, however, that the correction factor can be a function of any combination of the integer value, the original mantissa value, or any preceding corrected mantissa values.

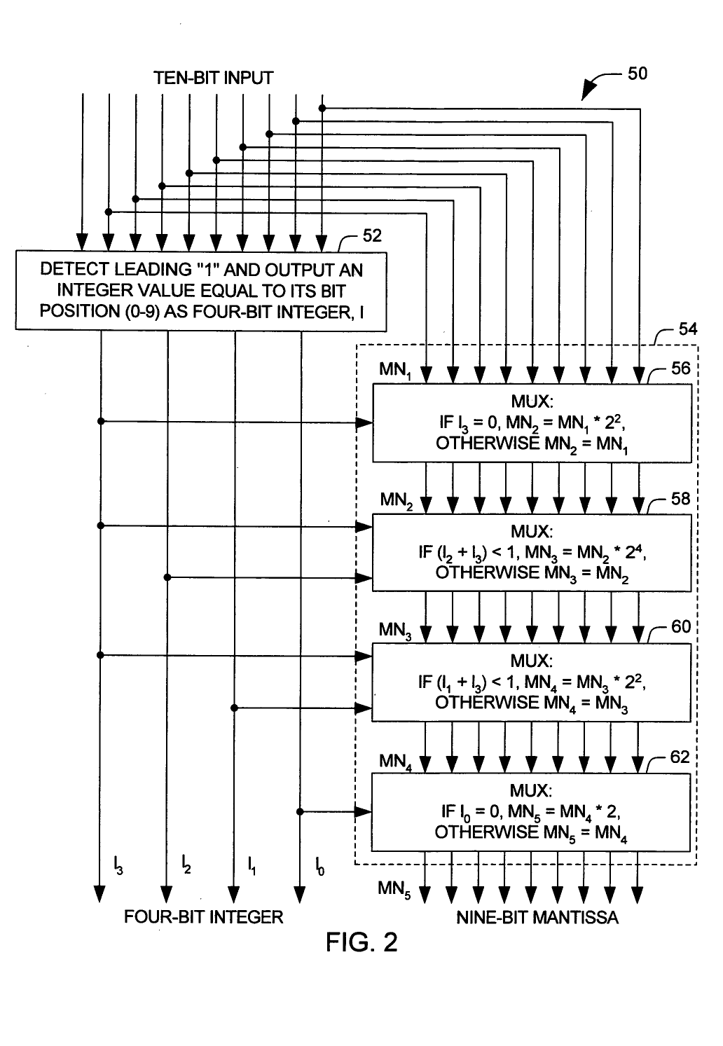

FIGS. 2-4 illustrate an exemplary logarithmic conversion system. In the illustrated example, the logarithmic converter is a base-two logarithmic converter, optimized for processing an input ten-bit binary value to produce an output comprising a four-bit integer value and a ten-bit mantissa value. It will be appreciated that the logarithmic conversion system of the present invention can be adapted to produce logarithmic values having a base other than two or to process input values having a bit-size other than ten bits. The specifics of the implementation, specifically the action of the multiplexers and the size of the various components, and the interconnections between the components, will vary with the base of the logarithm and the bit-size of the input.

FIG. 2 illustrates a block diagram of an exemplary base-two basic logarithmic converter 50 in accordance with an aspect of the present invention. The basic logarithmic converter 50 can be implemented as software on a general purpose processor or as specialized hardware components. In the illustrated example, the converter 50 is implemented as logic circuitry on an application specific integrated circuit chip. The basic logarithmic converter 50 comprises an integer determination portion 52 and a linear interpolation portion 54. The integer determination portion 52 determines an integer portion (I) for the received value. Since the exemplary system uses a logarithmic base of two, the integer value of the logarithm will be equal to the position of the most significant bit (MSB) of the digital value. For example, for a value of 9 (1001), the MSB is in the 2³ position. The integer value of the logarithm is thus 3. The integer value is output as a four-bit value, I, with digits I₃-I₀ representing 2³-2⁰ respectively. In the illustrated example, the integer determination portion 52 is implemented as a leading “one” detector and some associated logic circuitry that produces the four-bit representation of the integer.

The linear interpolation portion 54 then calculates a mantissa value (A) from a remainder generated by removing the MSB from the number. The original mantissa value, E, is equal to a ratio between this remainder and the difference in value between the I^{th} power of two and the (I+1)^{th} power of 2. Thus, the mantissa value represents the size of the remainder relative to the value that would be necessary to reach the next highest integer value for the logarithm. The interpolation for a value, V, would be calculated as follows:

$$A = \frac{V - {2}^{I}}{{2}^{I + 1} - {2}^{I}} \qquad Eq . 2$$

The interpolation can be simplified significantly in practice. For example, the denominator is simply 2^{I}, as in a base-two system, each integer value for the logarithm is twice the preceding value. The difference between these values is the value of the most significant bit. Additionally, when dealing with a binary value, the remainder is the original number with the leading one (the MSB) stripped from the number. Returning to an example value of 9, the mantissa value would be equal to 1 (001) divided by 8 (1000).

In the illustrated example, the linear interpolation portion 54 is implemented as a series of multiplexers 56, 58, 60, and 62. Each multiplexer receives one or more digits from the integer determination portion 52 as a control input and the last nine digits of the original number as an initial sample (A). Each multiplexer left-shifts the initial mantissa by a number of digits determined by the inputted digit values from the integer portion. At the end of the process, the leading one of the original number is stripped off, and the value originally to the right of the leading one occupies the far left (2⁻¹) position of the mantissa.

At the first multiplexer 56, the initial sample (A) is multiplied by four if the value of I₃ is zero. The sample is bit-shifted two spaces to the left, stripping the initial two digits, unless the determined integer value is eight or nine. If the value of the integer portion is eight or nine, the initial mantissa passes unchanged to a second multiplexer 58. At the second multiplexer 58, the mantissa value from the first multiplexer 56 (B) is multiplied by sixteen unless either I₂ or I₃ has a value of one. This shifts the received mantissa value four spaces to the left if the value of the integer portion is less than four. If the integer portion is greater than four, the received mantissa value is passed unchanged to a third multiplexer 60.

The third multiplexer 60 multiplies the mantissa value from the second multiplexer 58 (C) by four unless either I₁ or I₃ has a value of one. This shifts the received mantissa value two digits to the left where the value of the integer portion is zero, one, four, or five. Where the value of the integer portion is two, three, or a value greater than five, the mantissa value passes unchanged to a fourth multiplexer 62. Th fourth multiplexer 62 multiplies the value received from the third multiplexer 60 (D) by two unless I₀ has a value of one. This shifts the received mantissa value by one digit to the left when the value of the integer portion is even. When the value of the integer portion is odd, the mantissa value is output without change as an original mantissa value (E).

The cumulative effect of the four multiplexers 56, 58, 60, and 62 is to shift the last nine digits of the original number (the initial sample, A) by the number of digits necessary to strip away any leading zeros and the leading one. To accomplish this, it is necessary to shift the initial sample by a number of digits equal to the difference between nine and the position number of the MSB within the original number. By position number, it is meant the exponential power of two associated with each bit. Thus, the positions would be numbered from the left, starting with zero. In converting the array from an integer value to a fractional value, the numerical value of the remainder has already been effectively divided by the ninth power of two. For the purposes of interpolation, however, it is only necessary to divide by 2^{I}, and the value of I can be less than nine. The linear interpolation portion 54 effectively reverses this division by shifting the initial sample back to an appropriate starting digit.

For example, where the MSB is in the ninth position (e.g., the bit position representing 2⁹) of the input value, the linear interpolation portion 54 will not shift the position of the original mantissa. The sampled nine digits comprising the initial sample (A) already represent the original value stripped of its MSB. The value of I is nine, and the remainder has already effectively divided by 2⁹, so there is no need for further correction. Where the MSB is in the second position (e.g., the bit representing 2²), it is necessary to shift the nine digits seven places to eliminate the six leading zeros (2⁸-2³) of the initial sample as well as the leading one within the 2² position. Again, the remainder has been divided by 2⁹, but the integer value, I, is only two. Thus, an extraneous factor of 2⁻⁷ has been applied and it is necessary to shift the initial sample back by seven places.

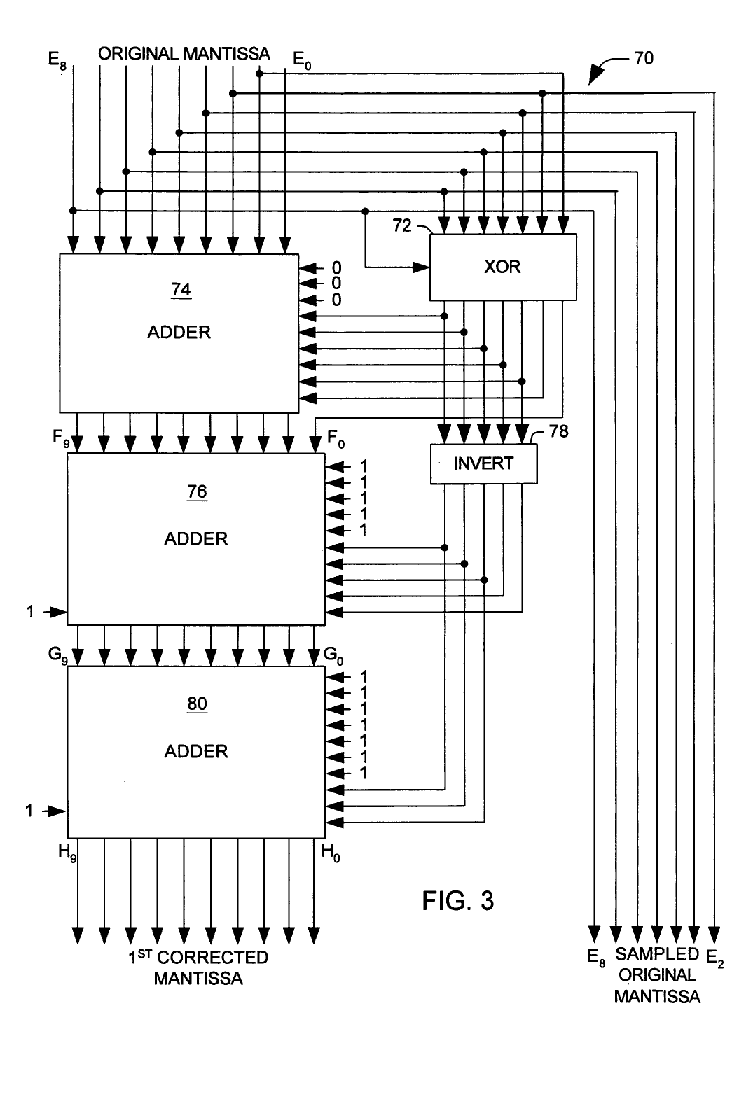

FIG. 3 illustrates a block diagram of a first correction stage 70 in accordance with the example embodiment. The exemplary embodiment is a base-two logarithm converter receiving a ten-bit input and producing an output comprising a four-bit integer value and a ten-bit mantissa value. It will be appreciated that the number of correction stages employed after the basic logarithm converter 50 is arbitrary, and that any number of stages may be used to refine the logarithmic approximation. Increasing the number of correction stages will increase the accuracy of the conversion at the cost of increased chip space and processing time.

At the first correction stage 70, the middle seven digits (E₇-E₁) of the original mantissa value (E₄) from the basic logarithmic converter 50 are sampled and provided to a seven bit XOR gate 72. The lead bit (E₈) of the mantissa value is provided as a control bit to the XOR gate 72. The XOR gate 72 allows the seven-digit sample to pass through unchanged where the value of the control bit is zero (i.e., the original mantissa value is less than one-half), but produces the complement of the seven-digit sample when the value of the control bit is one. The first six digits of the output from the XOR gate 72 are provided as one input to a first adder 74. In the illustrated example, the first adder 74 is a nine-bit adder. The first six bits from the XOR gate 72 are shifted into the bottom six positions, with three initial zeros. As the digits output from the XOR gate 72 are shifted two places from their original position in the mantissa when input to the first adder 74, a value equal to one-fourth the output of the XOR gate 72 is provided to the adder 74. The original mantissa value (E) is provided as a second input to the first adder 74. The nine-bit sum of these values (F) is provided to a second adder 76 as a first input, along with the seventh bit from the XOR gate 72 comprising a tenth digit.

The leading five digits from the XOR gate 72 are sampled and provided to a five-bit inverter 78. The inverter 78 produces the complement of the five-bit sample and passes the five-digit complement as a second input to the second adder. The five digits from the inverter 78 are provided as the last five digits of a ten-bit input, along with five leading ones. The second adder 76 also receives a carry-in input of one. As the bits output from the XOR gate 72 are shifted four places from their original position in the mantissa when input to the second adder 76, the second adder has the effect of subtracting a value equal to one-sixteenth the output of the XOR gate 72 from the output of the first adder (F). The resulting difference (G) is provided as a first input to a third adder 80.

The leading three bits output from the inverter 78 are sampled and provided to the third adder 80 as the last three digits of a ten-bit second input. The first seven bits comprise a series of leading ones. A carry-in input of one is also provided to the adder 80. As the output of the XOR gate is now shifted six digits from its original position, the third adder 80 effectively subtracts one sixty-fourth the value of the XOR input from the output of the second adder 76. The cumulative effect of the first correction stage is to add eleven sixty-fourths of the original mantissa value, or its compliment when the mantissa value exceeds one-half, to the mantissa to produce a first corrected mantissa value (H). The correction function of the first correction stage can be expressed mathematically as follows in terms of the first corrected mantissa value (H) and the original mantissa value (E):

$$H = \{ \begin{matrix} E + \frac{11 E}{64} ⇒ 0 \leq E < 0.5 \\ E + \frac{11 ( 1 - E )}{64} ⇒ 0.5 \leq E < 1\end{matrix} \qquad Eq . 3$$

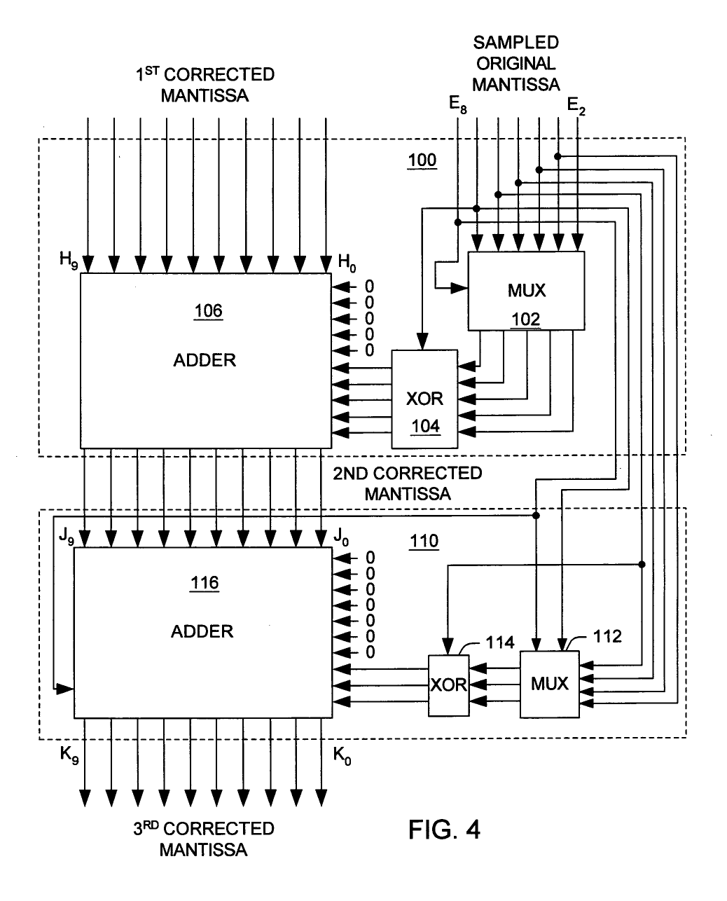

FIG. 4 illustrates the second and third correction stages 100 and 110, in accordance with one aspect of the present invention. The exemplary embodiment is a base-two logarithm converter receiving a ten-bit input and producing an output comprising a four-bit integer value and a ten-bit mantissa value.

A sample of the leading seven bits (E₈-E₂) of the original mantissa value (E) is provided to the second correction stage 100 along with the ten-bit first corrected mantissa (H). The sampled bits of the original mantissa are received at a first multiplexer 102. The multiplexer 102 receives the leading bit (E₈) of the sample as a control bit and the other six bits as input. The multiplexer 102 selects a set of five bits to pass to a second XOR gate 104 as a multiplexed sample, according to the value of a control bit, E₈. The multiplexer 102 selects the first five bits (E₇-E₃) of the received sample as the multiplexed sample when the value of th control bit, E₈, is one. The multiplexer 102 selects the last five bits (E₆-E₂) of the sample when the value of the control bit is zero.

The second XOR gate 104 receives the multiplexed sample as a five-bit input, and the second leading bit (E₇) of the original mantissa as a control bit. The XOR gate 104 produces the complement of the received value where the value of the control bit is one. Where the value of the control bit (E₈) at the multiplexer 102 was equal to one, the leading bit of the multiplexed sample will be E₇. Since the control bit of the XOR gate 104 is also E₇, this will always result in a leading zero in the five-bit output of the XOR gate. The action of the multiplexer 102 and the XOR gate 104 effectively divide the sample value by two where the original mantissa value exceeds one-half. The output of the XOR gate 104 is provided to a fourth adder 106.

The fourth adder 106, receives the first corrected mantissa value (J) as one ten-bit input, and the five-bit output of the second XOR gate 104 with five leading zeroes as a second ten-bit output. The fourth adder 106 adds the two inputs to produce a second corrected mantissa value (J). For values of the original mantissa less than one-half, the leading bit of the XOR gate 104 output corresponds to the third leading bit of the original mantissa. In such a case, the five leading zeroes correspond to a three position shift, or a division by eight of the output of the XOR gate 114. For values of the original mantissa greater than one-half, the leading bit of the XOR gate 104 output corresponds to the second leading bit of the original mantissa. The five leading zeroes would then correspond to a four position shift, or a division by sixteen of the output of the XOR gate 114. The action of the second correction stage can be described mathematically in terms of the original mantissa (E), the first corrected mantissa value (H), and the second corrected mantissa value (J), as:

$$J = \{ \begin{matrix} H + \frac{E}{8} ⇒ 0 \leq E < 0.25 \\ H + \frac{( 0.5 - E )}{8} ⇒ 0.25 \leq E < 0.5 \\ H + \frac{( E - 0.5 )}{16} ⇒ 0.5 \leq E < 0.75 \\ H + \frac{( 1 - E )}{16} ⇒ 0.75 \leq E < 1\end{matrix} \qquad Eq . 4$$

The second corrected mantissa is passed to the third correction stage 110. The third correction stage also receives a sample of the first six digits (E₈-E₃) of the original mantissa. The last four bits (E₆-E₃) are provided as an input to a second multiplexer 112. The leading two bits are provided as control bits to the second multiplexer 112. The second multiplexer 112 selects a set of three output values according to the values of the control bits. Where the values of both of the control bits are 0 (i.e. the original mantissa value is less than 0.25), an output set comprising the last three bits (E₅-E₃) is selected. Where the values of either of the control bits is one, an output set comprising bits the leading three bits of the four input bits (E₆-E₄) is selected. The selected output set is then passed to a third XOR gate 114.

The third XOR gate 114 receives the multiplexed sample as a three-bit input, and the third bit (E₆) of the original mantissa as a control bit. Where the values of the control bits (E₈ and E₇) at the second multiplexer 112 were not mutually zero, the leading bit of the multiplexed sample will be E₆. Since the control bit of the third XOR gate 114 is also E₆, this will always result in a leading zero in the three-bit output of the third XOR gate. The action of the second multiplexer 112 and the third XOR gate 114 effectively divide the sample value by two where the original mantissa value exceeds one-quarter. The XOR gate 114 produces the complement of the received value where the value of the control bit is one. The output of the XOR gate 114 is provided to a fifth adder 116.

The fifth adder 116, receives the second corrected mantissa value (J), as one ten-bit input. The second ten-bit output comprises the three-bit output of the third XOR gate 114 with seven leading zeroes. The fifth adder 116 adds the two inputs to produce a final corrected mantissa value (K). For an original mantissa value less than one-fourth, the leading bit of the XOR gate 114 output corresponds to the fourth leading bit of the original mantissa. In such a case, the seven leading zeroes correspond to a four position shift, or a division by sixteen of the output of the XOR gate 114. For an original mantissa value greater than one-fourth, the leading bit of the XOR gate 114 output corresponds to the third leading bit of the original mantissa. The seven leading zeroes would then correspond to a five position shift, or a division by thirty-two of the output of the XOR gate 114. The action of the third correction stage can be described mathematically in terms of the original mantissa (E), the second corrected mantissa value (J), and the third corrected mantissa value (K) as:

$$K = \{ \begin{matrix} J + \frac{E}{16} ⇒ 0 \leq E < 0.125 \\ J + \frac{( 0.25 - E )}{16} ⇒ 0.125 \leq E < 0.25 \\ J + \frac{( E - 0.25 )}{32} ⇒ 0.25 \leq E < 0.375 \\ J + \frac{( 0.5 - E )}{32} ⇒ 0.375 \leq E < 0.5 \\ J + \frac{( E - 0.5 )}{32} ⇒ 0.5 \leq E < 0.625 \\ J + \frac{( 0.75 - E )}{32} ⇒ 0.625 \leq E < 0.75 \\ J + \frac{( E - 0.75 )}{32} ⇒ 0.75 \leq E < 0.875 \\ J + \frac{( 1 - E )}{32} ⇒ 0.875 \leq E < 1\end{matrix} \qquad Eq . 5$$

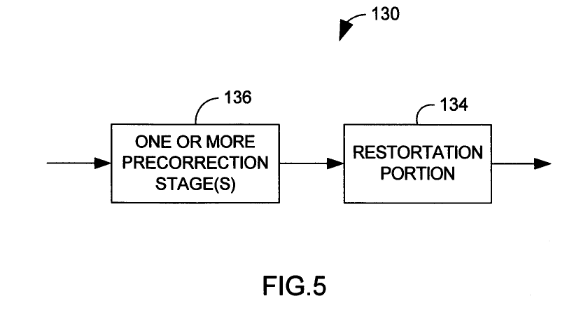

FIG. 5 illustrates a functional block diagram of an inverse logarithmic conversion system 130 in accordance with one aspect of the present invention. The inverse logarithmic converter 130 receives an input value having an associated integer value (Z) and an initial mantissa value and produces an output equal to a predetermined base taken to an exponential factor equal to the input value. The inverse logarithmic converter 130 can be implemented as software on a general purpose processor. Alternatively, the inverse logarithmic converter can be implemented as specialized hardware components. For Example, the inverse logarithmic converter may be implemented as logic circuitry as part of an application specific integrated circuit.

The initial mantissa value is provided to one or more precorrection stages 132. Any number of precorrection stages can be employed, depending on the desired accuracy of the application and the desired processing time. Additional precorrection stages can increase the accuracy of the conversion at the cost of an increase in the required processing time and chip space.

For example, at a first precorrection stage, a first precorrection factor can be applied to the initial mantissa value to produce a first precorrected mantissa value. The first precorrected mantissa value can then be provided to a second precorrection stage. At the second precorrection stage, a second precorrection factor is applied to the first precorrected mantissa to produce a second precorrected mantissa value. The second precorrected mantissa value can then be provided to further precorrection stages, each stage providing a precorrection factor until a desired degree of accuracy is achieved. In accordance with one aspect of the invention, the precorrection factor at each stage can be a function of the initial, uncorrected, mantissa value. It will be appreciated, however, that the precorrection factor can be a function of any combination of the integer value, the initial mantissa value, or any preceding precorrected mantissa values.

The restoration portion 134 produces an inverse logarithmic value from the precorrected mantissa value and the integer value. The restoration portion 134 tranforms the received value from the logarithmic domain by performing a combination function and a multiplication function. For example, the mantissa can be multiplied by a restoration factor equal to the difference between consecutive integer powers of the base N (e.g., N^{Z} and N^{Z+1}). The product of these values can be added to a base portion, equal to the logarithmic base taken to the power of the integer value (e.g., N^{Z}). Alternatively, a value can be derived from the integer value and added to the mantissa prior to multiplication by the restoration factor. The resulting value provides an estimate of the inverse logarithm of the number represented by the integer value and the mantissa.

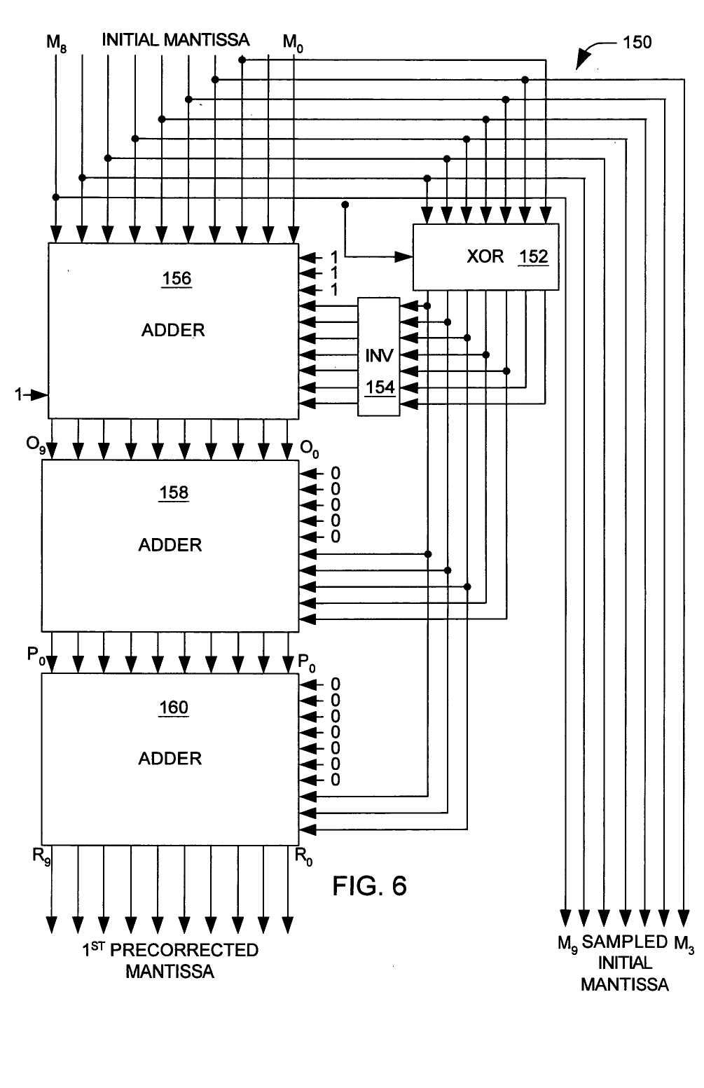

FIGS. 6-8 illustrate an exemplary inverse logarithmic converter. The inverse logarithmic converter of the illustrated example is a base-two inverse logarithmic converter, optimized for processing an input binary value comprising a four bit integer value and a nine-bit mantissa value. It will be appreciated that the logarithmic conversion system of the present invention can be adapted to logarithms having a base other than two or to additional bit-sizes.

FIG. 6 illustrates a block diagram of a first precorrection stage 150 of the exemplary base-two logarithmic converter in accordance with one aspect of the present invention. It will be appreciated that the number of correction stages used to adjust the mantissa of the logarithmic value before it is submitted to the basic inverse logarithm converter 150 is arbitrary, and that any number of stages may be used to refine the approximation. Increasing the number of precorrection stages will increase the accuracy of the conversion at the cost of increased chip space and processing time.

The first precorrection stage 150 begins when the first eight digits (M₉-M₂) of the initial mantissa value (M) of the logarithm are sampled and provided to a seven bit XOR gate 152. The lead bit (M₉) of the initial mantissa value (M) is provided as a control bit to the seven-bit XOR gate 152, while the other seven bits from the sample (M₈-M₂) are provided as an input. The seven-bit XOR gate 152 thus allows the seven-digit sample to pass through unchanged where the logarithm mantissa value is less than one-half, but produces the complement of the mantissa when the mantissa value is greater than one-half.

The seven-bit output of the XOR gate 152 is then provided to a seven-bit inverter 154 that produces a complement of the seven-bit output. This complement is provided as one input to a first adder 156. In the illustrated example, the first adder 156 is a ten-bit adder. The seven-bit complement is shifted into the bottom seven positions, with three leading ones. As the digits output from the XOR gate 152 are shifted two places from their original position in the mantissa when input to the first adder 156, a value equal to one-fourth the output of the XOR gate 152 is provided to the adder. The logarithm mantissa value (M) is provided as a second input to the first adder 156. A carry value of one is provided to the adder. The difference (O) between the logarithm mantissa value and the output of the seven-bit XOR gate 152 is provided to a second adder 158 as a first input.

The leading five digits from the XOR gate 152 are sampled and provided to the second adder 158. The five digits from the XOR gate 152 are provided as the last five digits of a ten-bit input, along with five leading zeroes. As the digits output from the XOR gate 152 are shifted four values from their original position within the mantissa when input to the second adder 158, the second adder has the effect of adding a value equal to one-sixteenth the output of the XOR gate 152 to the output (O) of the first adder 156. The resulting sum (P) is provided as a first input to a third adder 160.

The leading three digits from the XOR gate 152 are sampled and provided to the third adder 160. The three digits from the XOR gate 152 are provided as the last three digits of a ten-bit input, along with seven leading zeroes. As the digits output from the XOR gate 152 are shifted six values from their original position within the mantissa when input to the third adder 160, the third adder has the effect of adding a value equal to one sixty-fourth the output of the XOR gate 152 to the output (P) of the second adder 158. The output of the third adder 160 is a first precorrected mantissa (R). The cumulative effect of the first precorrection stage is to subtract eleven sixty-fourths of the logarithm mantissa value, or its compliment when the mantissa value exceeds one-half, to the mantissa to produce the first precorrected mantissa value (R). The correction function of the first correction stage can be expressed mathematically as follows in terms of the first precorrected mantissa value (R) and the initial logarithm mantissa value (M) as:

$$R = \{ \begin{matrix} M - \frac{11 M}{64} ⇒ 0 \leq M < 0.5 \\ M - \frac{11 ( 1 - M )}{64} ⇒ 0.5 \leq M < 1\end{matrix} \qquad Eq . 6$$

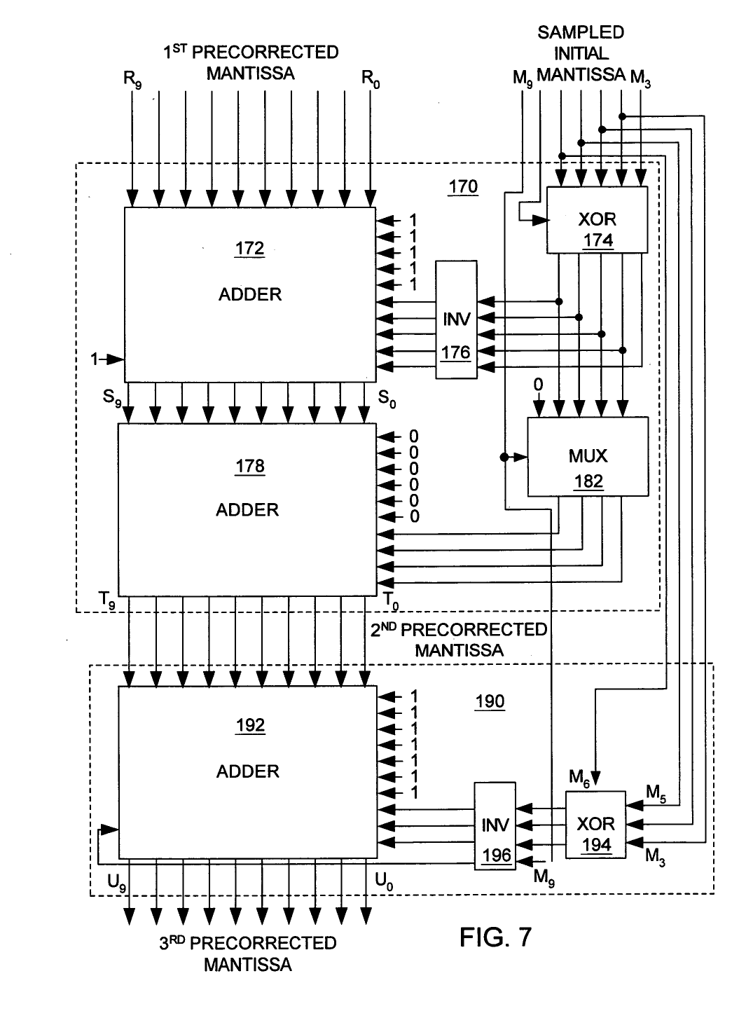

FIG. 7 illustrates a block diagram of a second precorrection stage 170 and a third precorrection stage 190 of an exemplary base-two inverse logarithmic converter in accordance with an aspect of the present invention. The inverse logarithmic converter of the illustrated example is a base-two inverse logarithmic converter, optimized for processing an input binary value comprising a four bit integer value and a nine-bit mantissa value.

The second precorrection stage 170 receives the first precorrected mantissa value as a first input at a fourth adder 172. Five bits from the initial mantissa (M₇-M₃) are sampled and provided to a five-bit XOR gate 174 as an input. The second leading bit of the initial mantissa (M₈) is sampled and provided as a control bit. The five-bit XOR gate 174 thus allows the five-digit sample to pass through unchanged where the value of the control bit is zero (i.e., the initial mantissa has a value less than one-fourth or a value between one-half and three-fourths), but produces the complement of the mantissa when the value of the control bit is equal to one.

The five-bit output of the XOR gate 174 is then provided to a five-bit inverter 176 that produces a complement of the five-bit output. This complement is provided as a second input to the fourth adder 172. In the illustrated example, the fourth adder 172 is a ten-bit adder. The five-bit complement is shifted into the bottom five positions, with five leading ones. As the digits output from the XOR gate 174 are shifted three places from their original position within the mantissa when input to the fourth adder 172, the fourth adder 172 has the effect of subtracting a value equal to one-eighth the output of the five-bit XOR gate 174 to the first precorrected mantissa (R). The difference (S) between the two values is provided to a fifth adder 178 as a first input.

The leading four bits of the output of the five-bit XOR gate are sampled and provided as an input to a multiplexer 182. The leading bit of the initial mantissa (M₉) is provided as a control bit. The multiplexer 182 selects a set of four bits to provide to the fifth adder 178 as a second input. Where the control bit is equal to zero (e.g., the initial mantissa value is less than one-half), the four-bit sample from the XOR-gate 174 passes through the multiplexer 182 unchanged. Where the control bit is equal to one, the multiplexer 182 shifts the digits one space to the right and adds a leading zero. The multiplexer 182 effectively divides the sampled XOR gate 174 output by two when the value of the initial mantissa is greater than or equal to one-half.

The output of the multiplexer is provided as a second input to the fifth adder 178. The four-bit output of the multiplexer 182 is provided with six leading zeroes as a ten-bit input. The digits output from the XOR gate 174 are shifted four places from their original position within the mantissa when the control bit (M₉) of the multiplexer was equal to zero and five digits when the control bit was equal to one. Thus, the fifth adder 178 has the effect of adding a value equal to one-sixteenth the output of the five-bit XOR gate 174 when the initial mantissa value is less than one-half and adding a value equal to one thirty-second of the output of the XOR gate 172 when the initial mantissa value was greater than or equal to one-half. The sum of the output of the fourth adder 172 and the selected output from the XOR gate 174 provide a second precorrected mantissa value (T). The correction function of the second correction stage 170 can be expressed mathematically in terms of the first precorrected mantissa value (R), the second corrected mantissa value (T) and the initial logarithm mantissa value (M) as:

$$T = \{ \begin{matrix} R - \frac{M}{16} ⇒ 0 \leq M < 0.25 \\ R - \frac{( 0.5 - M )}{16} ⇒ 0.25 \leq M < 0.5 \\ R - \frac{3 ( M - 0.5 )}{32} ⇒ 0.5 \leq M < 0.75 \\ R - \frac{3 ( 1 - M )}{32} ⇒ 0.75 \leq M < 1\end{matrix} \qquad Eq . 7$$

The output (T) of the fifth adder is received within the third correction stage as a first input to a sixth adder 192. A sample of three bits from the initial mantissa (M₆-M₄) is provided as an input to a three-bit XOR gate 194. The third leading bit (M₇) is provided to the three-bit XOR gate 194 as a control bit. The three-bit XOR gate 194 allows the three-digit sample to pass through unchanged where the value of the control bit is zero, but produces the complement of the three-bits when the value of the control bit is equal to one.

The output of the three-bit XOR gate 194 is provided to a four-bit inverter 196, along with a sample of the leading bit (M₉) of the initial mantissa. A complement of the three bits from the XOR gate is provided as a second input to the sixth adder 192 along with seven leading ones. The inverted leading bit from the initial mantissa (M₉) is provided to the sixth adder 192 as a carry-in bit. The digits output from the three-bit XOR gate 194 are shifted four values from their original position within the mantissa when input to the sixth adder 192. The sixth adder 192 thus has the effect of subtracting a value equal to one-sixteenth the output of the XOR gate to the second precorrected mantissa. The resulting difference is a third precorrected mantissa value (U). The correction function of the third correction stage 170 can be expressed mathematically in terms of the second precorrected mantissa value (T), the third corrected mantissa value (U), and the initial logarithm mantissa value (M) as:

$$U = \{ \begin{matrix} T + \frac{M}{16} ⇒ 0 \leq M < 0.125 \\ T + \frac{( 0.25 - M )}{16} ⇒ 0.125 \leq M < 0.25 \\ T + \frac{( M - 0.25 )}{16} ⇒ 0.25 \leq M < 0.375 \\ T + \frac{( 0.5 - M )}{16} ⇒ 0.375 \leq M < 0.5 \\ T + \frac{( M - 0.5 )}{16} ⇒ 0.5 \leq M < 0.625 \\ T + \frac{( 0.75 - M )}{16} ⇒ 0.625 \leq M < 0.75 \\ T + \frac{( M - 0.75 )}{16} ⇒ 0.75 \leq M < 0.875 \\ T + \frac{( 1 - M )}{16} ⇒ 0.875 \leq M < 1\end{matrix} \qquad Eq . 8$$

In the illustrated example, the third precorrected mantissa value is the final output of the precorrection stages 150, 170, and 190.

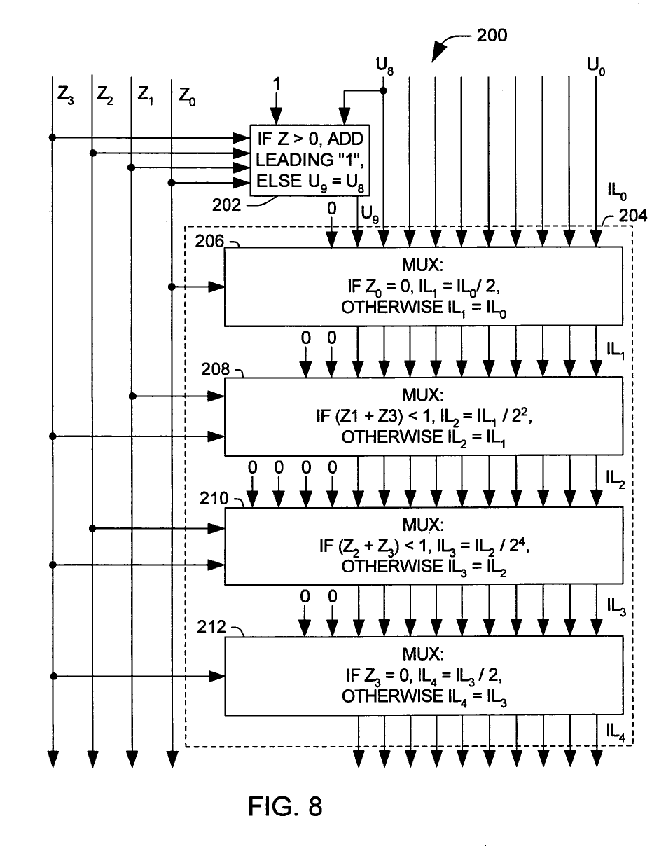

FIG. 8 illustrates a block diagram of an exemplary basic inverse logarithmic converter 200 in accordance with an aspect of the present invention. The inverse logarithmic converter of the illustrated example is a base-two inverse logarithmic converter, optimized for processing an input binary value comprising a four bit integer value and a nine-bit mantissa value. The basic logarithmic converter 200 can be implemented as software on a general purpose processor or as specialized hardware components. In the illustrated example, the basic logarithmic converter 200 is implemented as logic circuitry on an application specific integrated circuit.

The basic inverse logarithmic converter 200 comprises a header portion 202 and a restoration portion 204. The header portion 202 adds a leading one to the precorrected mantissa value as a tenth bit. Conceptually, the bit is added in the 2^{z} position of a new ten-bit binary number. From a mathematical standpoint, it is then necessary to multiply the number by two to the power of the integer portion of the logarithm (2^{z}), such that the leading one is in the position corresponding to 2^{z}. The illustrated embodiment treats the former mantissa value, with the added leading one, to be a ten-bit integer value of the inverse logarithm. This effectively shifts the leading one to the position corresponding to 2⁹. The restoration portion 204 then divides the result by appropriate values to shift the leading bit into the appropriate position.

In the illustrated example, the restoration portion 204 is implemented as a series of multiplexers 206, 208, 210, and 212. Each multiplexer receives one or more digits representing an integer portion of the logarithm as control input and the ten-digit binary number as an initial inverse logarithm (IL₀). Each multiplexer divides (right-shifts) the inverse logarithm value by a factor determined by the inputted digit values from the integer portion. At the end of the process, the leading one added at the header portion 202 is placed in the 2^{z} position, and the precorrected mantissa value provided to the inverse log converter has been multiplied by 2^{z} to produce an inverse logarithm value.

The first multiplexer 206 divides the inverse logarithm value received from the header portion 202 (IL₀) by two unless Z₀ has a value of one. This shifts the received inverse logarithm value by one digit to the right when the value of the integer portion is even. When the value of the integer portion is odd, the inverse logarithm value is output without change to a second multiplexer 208. The second multiplexer 208 divides the output from the first multiplexer 206 (IL₁) by four unless either Z₁ or Z₃ has a value of one. This shifts the received inverse logarithm value two digits to the right where the value of the integer portion is zero, one, four, or five. Where the value of the integer portion is two, three, or a value greater than five, the inverse logarithm value passes unchanged to a third multiplexer 210.

At the third multiplexer 210, the output from the second multiplexer 208 (IL₂) is divided by sixteen unless either Z₂ or Z₃ has a value of one. This shifts the received inverse logarithm four spaces to the right if the value of the integer portion is less than four. If the integer portion is greater than four, the inverse logarithm value is passed unchanged to a fourth multiplexer 212. At the fourth multiplexer 212, the output (IL₃) of the third multiplexer 210 is multiplied by four if the value of Z₃ is zero. The received inverse logarithm value is bit-shifted two spaces to the right, unless the determined integer value is eight or nine. The bit-shifted value provides a final value (IL₄) for the inverse logarithm. If the value of the integer portion is eight or nine, the initial inverse logarithm value passes unchanged as a final value (IL₄) for the inverse logarithm For example, where the integer value is nine, the restoration portion 204 will not shift the position of the binary number. The leading one was placed into the 2⁹ position initially and does not need to be moved. Where the leading digit is in the second position (e.g., the bit representing 2²), however, it is necessary to shift the binary number seven places to place the leading one into the 2² position. Essentially, we have multiplied by 2⁹ when the mantissa is treated as an integer, but the integer value, Z, is only two. Thus, we have overmultiplied by a factor of 2⁷ and it is necessary to shift the inverse logarithm value back by seven places

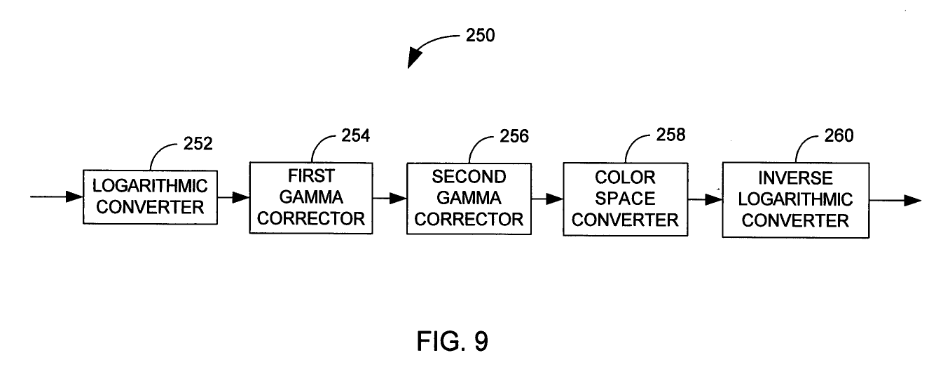

FIG. 9 illustrates a block diagram of a video correction system 250 in accordance with an aspect of the present invention. The video correction system 250 adjusts an exponential gamma factor associated with an input signal to account for the non-linear response of a display associated with the video correction system. The illustrated system is configured to receive an input signal in the RGB (Red, Green, Blue) color space domain, having an associated gamma correction, and output a signal in the YCbCr (Luminescence, Blue Chromaticity, and Red Chromaticity) color space domain having a gamma correction associated with a system display. The illustrated system 250 can be implemented as hardware components on one or more integrated circuits. Alternatively, one or more of the illustrated functions may be implemented as software on a general purpose processor or controller. In the illustrated example, the various components are implemented as hardware in a single application specific integrated circuit (ASIC).

The system 250 receives an input signal at one or more logarithmic converters 252, designed in accordance with present invention. The logarithmic converters 252 generate representations of their respective input signals in the logarithmic domain. In the illustrated example, the input signal is a digital signal consisting of three chromatic components, R, G, and B, each representing a different chromaticity value. In the illustrated example, the logarithmic representation is equal to the base-two logarithm of the component signal values. The logarithmic converter 252 can be implemented as software on a general purpose processor, or as a series of hardware components.

The logarithmic signal representation is passed to a first gamma corrector 254 that removes an associated gamma value of the input signal. In the illustrated example, an exponential gamma correction factor can be provided to the signal as a multiplicative correction factor, as the input signal is represented in the logarithmic domain. The correction factor will be equal to the multiplicative inverse of the gamma associated with the input signal and will generally have a value greater than one. In the illustrated example, the correction factor is provided by an operator and may be adjusted during operation. The first gamma corrector 254 outputs the corrected input signal to a second gamma corrector 256.

The second gamma corrector 256 applies a gamma value associated with a system display to th input signal. Unlike th first gamma corrector 254, which remove a prior gamma correction from the signal, the second gamma corrector 256 a gamma correction value specific to the system display to the signal. This value depends only on the properties of the display, and is provided by an operator as a configuration parameter. This gamma value is applied as a multiplicative correction factor to the logarithmic representation of the three signal components, (e.g., R, G, and B). This applied gamma correction value is generally less than one, and accounts for the non-linear response of the display associated with the system. The output of the second gamma corrector 256 is a signal in the RGB domain gamma corrected for the display.

The output of the second gamma corrector 256 is received at a chromaticity converter 258. At the chromaticity converter 258, the gamma corrected RGB signal from the second gamma corrector 256 is converted into the YCbCr color space domain. This is accomplished by a matrix multiplication of the three component values for the signal and a matrix of conversion coefficients. The output of the chromaticity corrector/converter 256 will be a signal having three components, each a linear combination of the three input components.

The output signal from the chromaticity converter 258 is provided to one or more inverse logarithmic converters 260, in accordance with the present invention. At the inverse logarithmic converters 260, the signal is converted from the logarithmic domain to a standard domain. The inverse logarithmic converters 260 will have the same associated logarithmic base as the logarithmic converters 252, essentially reversing the original logarithmic transformation of the signal components. The output of the inverse logarithmic converters 260 is a YCbCr domain signal having an appropriate gamma correction for the associated display.

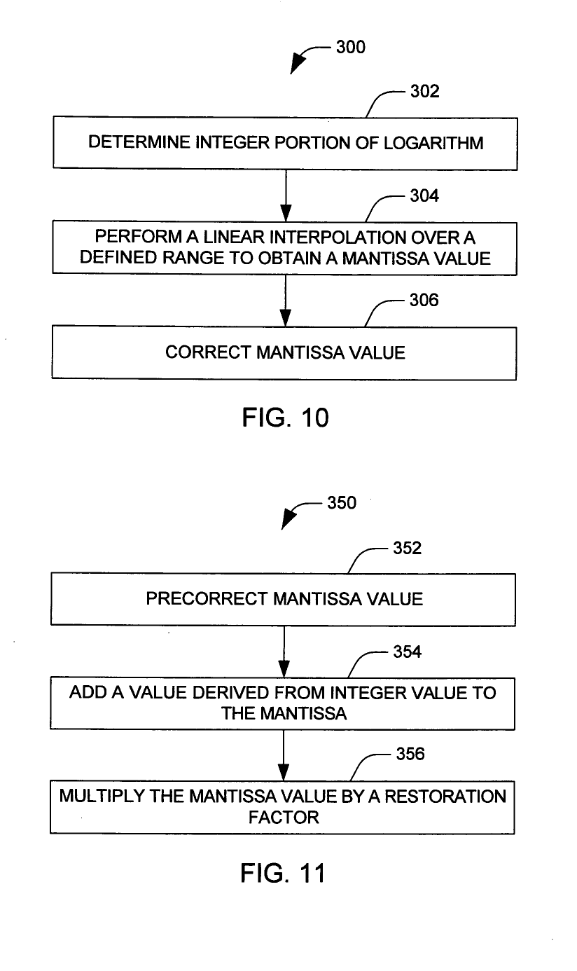

FIG. 10 illustrates an exemplary methodology 300 for converting an input value into its logarithmic representation. At 302, the system determines an integer value associated with the logarithm. This can be accomplished by consulting a look-up table for an integer value associated with input value, detecting a characteristic, such as a the position of a leading one, of the value, or submitting the value to a series of logical comparators. The integer value is the whole number portion of the logarithm of the value.

A mantissa value is determined at 304 via linear interpolation. Specifically, a linear interpolation of the input value is determined across a range defined by two consecutive integer powers of the logarithmic base. Specifically, the range is bounded by the I^{th} power of the base and the (I+1)^{th} power of the base. The determined value becomes an original mantissa value. The linear interpolation can be implemented as logic circuitry or calculated within a general processor or controller as part of a software program.

At 306, the mantissa value is corrected. This correction can take the form of one or more correction stages adding or subtracting a correction factor from the mantissa value. Each successive stage will add or subtract its particular correction factor from the result of the previous stage. In one embodiment of the invention, the correction factor at each stage is determined as a function of the original, uncorrected mantissa value.

FIG. 11 illustrates an exemplary methodology 350 for producing the inverse logarithm of a particular base for an input value comprising an integer value and an initial mantissa value. At 352, the mantissa value is precorrected. This precorrection can take the form of one or more precorrection stages adding or subtracting a precorrection factor from the mantissa value. Each successive stage will add or subtract its particular precorrection factor from the result of the previous stage. In one embodiment of the invention, the precorrection factor at each stage is determined as a function of the initial, uncorrected mantissa value.

At 354, a value derived from the integer value is added to the precorrected mantissa value. The specifics of this value will depend on the base of the logarithm and the nature of the input value. In a base-two logarithm having a ten-bit digital input, a value of one is appropriate. At 356, the sum of the value derived from the integer value and the precorrected mantissa value is multiplied by a restoration factor. For example, the restoration factor can be equal to the difference between consecutive integer powers of the base N (e.g., N^{Z} and N^{Z+1}). This product provides an accurate approximation of the inverse logarithm of the input value.

It will be appreciated that the combination function 354 and the multiplication function 356 of the restoration portion are interchangeable. For example, the mantissa can be multiplied by a restoration factor equal to the difference between consecutive integer powers of the base N (e.g., N^{Z} and N^{Z+1}). The product of these values can then be added to a base portion, equal to the logarithmic base taken to the power of the integer value (e.g., N^{Z}), to obtain the inverse logarithm. The order in which these functions are performed will vary with the application and with the specific implementation of the converter.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A logarithmic conversion system that determines a logarithm of a number, the logarithm having an associated base, comprising:
an integer determination portion, that determines an integer value associated with the logarithm;
an interpolation portion that performs a linear interpolation of the number over a range defined by two consecutive integer powers of the logarithmic base, to obtain a mantissa value, the consecutive integers including the integer value; and
at least one correction stage, each of the at least one correction stages applying a correction factor to the mantissa value.

2. The system of claim 1, the correction factor applied at each of the at least one correction stages being a function of the mantissa value.

3. A video correction system comprising the system of claim 1.

4. A logarithmic conversion system, comprising:
a leading one detector that determines the position of the leading one of a binary number to determine an integer value;
at least one multiplexer that shifts the digits of the binary number such that the digit following the leading one occupies a first bit position of the number to determine a mantissa value; and
at least one adder operative to add a value to the mantissa value.

5. A video correction system comprising the system of claim 4.

6. The system of claim 4, the at least one adder comprising a first adder that receives the mantissa value as a first input and a sample of the mantissa value processed at one or more logical circuitry components as a second input.

7. A method for determining the logarithm of an input value, the logarithm having an associated base comprising:
determining an integer value associated with the logarithm;
performing a linear interpolation of the number over a range bounded by consecutive integer powers of the logarithmic base to obtain a mantissa value, the consecutive integers including the integer value; and
adding at least one correction factor to the mantissa value.

8. The method of claim 7, the input value being represented in binary form, and the determination of an integer value associated with the logarithm comprising detecting the location of the leading one of the input value.

9. The method of claim 8, the performance of the interpolation comprising shifting the digits of the binary value such that the digit following the leading one occupies a first bit position of the binary value.

10. The method of claim 7, each of the at least one correction factor being a function of the mantissa value.

11. An inverse logarithmic conversion system that receives an input value, comprising an integer value and a mantissa value and determines the inverse logarithm of the input value for a predetermined base, comprising:
at least one precorrection stage, each precorrection stage applying a correction factor to the mantissa value, producing a precorrected mantissa value; and
a restoration portion that adds a value derived from the integer value to the precorrected mantissa and multiplies the precorrected mantissa value by a restoration factor qual to the difference between two consecutive integer powers of the logarithmic base, the consecutive integers including the integer value.

12. A video correction system comprising the system of claim 11.

13. The system of claim 11, the correction factor applied at each of the at least one precorrection stage being a function of the mantissa value.

14. An inverse logarithmic conversion system that produces the inverse logarithm of an input value comprising an integer value and a mantissa value:
at least one adder that applies a correction factor to the mantissa value;
a header portion that adds a leading one to the mantissa value; and
at least one multiplexer that shifts the digits of the binary number such that the leading one occupies a bit position associated with the integer value.

15. A video correction system comprising the system of claim 14.

16. The system of claim 14, the at least one adder comprising a first adder that receives the mantissa value as a first input and a sample of the mantissa value processed at one or more logical circuitry components as a second input

17. A method for determining the inverse logarithm of an input value, the logarithm having an associated base comprising and the input value comprising an integer value and a mantissa value, comprising:
applying at least one precorrection factor to the mantissa value;
adding a value derived from the integer value to the precorrected mantissa; and
multiplying the precorrected mantissa value by a restoration factor equal to the difference between two consecutive integer powers of the logarithmic base, the consecutive integers including the integer value.

18. The method of claim 17, the mantissa being represented in binary form, and the addition of an value representing the integer value of the logarithm comprising adding a leading one to the mantissa value.

19. The method of claim 18, the multiplication of the precorrected mantissa value by a restoration factor comprising shifting the digits of the binary number such that the leading one occupies a bit position associated with the integer value.

20. The method of claim 17, the at least one precorrection factors each being a function of the mantissa value.

21. A logarithmic conversion system for determining the logarithm of an input value, the logarithm having an associated base comprising:
means for determining an integer value associated with the logarithm;
means for defining a range bounded by consecutive integer powers of the logarithmic base, the consecutive integers including the integer value;
means for performing a linear interpolation of the number over the defined range to obtain a mantissa value; and
means for adding at least one correction factor to the mantissa value.

22. An inverse logarithmic conversion system that determines the inverse logarithm of an input value, the logarithm having an associated base comprising and the input value comprising an integer value and a mantissa value, comprising:
means for applying at least one precorrection factor to the mantissa value;
means for adding a value representing the integer value of the logarithm to the precorrected mantissa; and
means for multiplying the precorrected mantissa value by a restoration factor equal to the differ nce between two consecutive integer powers of the logarithmic base, the consecutive integers including the integer value.
